(19) United States
(12) Patent Application Publication
(10) Pub. No.: US 2025/0100635 A1
(43) Pub. Date: Mar. 27, 2025

(54) MILITARY VEHICLE WITH TRACK TENSIONING SYSTEM

(71) Applicant: Oshkosh Defense, LLC, Oshkosh, WI (US)

(72) Inventors: Nicholas Tafuri, Howell, MI (US); Benjamin LeVesque, Royal Oak, MI (US)

(73) Assignee: Oshkosh Defense, LLC, Oshkosh, WI (US)

(21) Appl. No.: 18/894,933

(22) Filed: Sep. 24, 2024

Related U.S. Application Data
(60) Provisional application No. 63/540,170, filed on Sep. 25, 2023.

(51) Int. Cl. B62D 55/30

(52) U.S. Cl. CPC B62D 55/30

(57) ABSTRACT

A track tensioning system includes a pair of dual accumulators. Each of the dual accumulators are configured to adjust a tension of a belt of a corresponding track assembly. The track tensioning system is configured to provide two-stage control of the tension of the belt.

### CROSS-REFERENCE TO RELATED PATENT APPLICATION

This application claims the benefit of and priority to U.S. Provisional Patent Application No. 63/540,170, filed Sep. 25, 2023, the entire disclosure of which is incorporated by reference herein.

### BACKGROUND

The present disclosure relates to a tracked vehicle. More particularly, the present disclosure relates to a remotely controlled vehicle.

### SUMMARY

One embodiment of the present disclosure is a military vehicle. The military vehicle includes a pair of track assemblies, and a track tensioning system. Each track assembly includes a belt and multiple rollers positioned within the belt. The pair of track assemblies are configured to be driven to transport the military vehicle. The track tensioning system includes a pair of dual accumulators. Each of the dual accumulators are configured to adjust a tension of the belt of a corresponding track assembly. The track tensioning system is configured to provide two-stage control of the tension of the belt.

Another embodiment of the present disclosure is a track tensioning system. The track tensioning system includes a pair of dual accumulators. Each of the dual accumulators are configured to adjust a tension of a belt of a corresponding track assembly. The track tensioning system is configured to provide two-stage control of the tension of the belt.

Another embodiment of the present disclosure is a driveline for a vehicle. The driveline includes a pair of track assemblies and a track tensioning system. The track assembly includes a belt and a multiple rollers positioned within the belt. The pair of track assemblies are configured to be driven to transport the vehicle. The track tensioning system includes a pair of dual accumulators, a reservoir, a manual pump, a pair of hydraulic lines, a pair of shut off valves, and a pair of pressure sensors. Each of the dual accumulators are configured to adjust a tension of the belt of a corresponding track assembly. The reservoir is configured to provide hydraulic fluid. The manual pump is fluidly coupled with the reservoir. The pair of hydraulic lines are each fluidly coupled with the manual pump. A corresponding cylinder is configured to adjust the tension in the belt, and a corresponding one of the dual accumulators. The pair of shut off valves are each positioned along one of the pair of hydraulic lines. Each pressure sensor is positioned along one of the pair of hydraulic lines. The track tensioning system is configured to provide two-stage control of the tension of the belt.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle, according to some embodiments.

FIG. 2 is a top view of a rear portion of the vehicle of FIG. 1 including an electric drive system, according to some embodiments.

FIG. 3 is a block diagram of a driveline of the vehicle of FIG. 1, according to some embodiments.

FIG. 4 is a block diagram of a control system for the vehicle of FIG. 1, according to some embodiments.

FIG. 5 is a perspective view of a track tensioning system of the vehicle of FIG. 1, according to some embodiments.

FIG. 6 is a top view of the track tensioning system of FIG. 5, according to some embodiments.

FIG. 7 is a diagram of an accumulator of the track tensioning system of FIG. 5 according to one embodiment.

FIG. 8 is a diagram of the accumulator of the track tensioning system of FIG. 5 according to another embodiment.

FIG. 9 is a diagram of the accumulator of the track tensioning system of FIG. 5 according to yet another embodiment.

FIG. 10 is a schematic diagram of the track tensioning system of FIG. 5, according to some embodiments.

FIG. 11 is a graph illustrating a response of the track tensioning system of FIG. 5 showing a relationship between belt tension and cylinder state, according to some embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, a track tensioning system for a military vehicle includes an oil reservoir, high pressure manual pump, independent right and left shut off valves, independent right and left dual gas pressurized accumulators, independent right and left pressure sensors, and independent left and right hydraulic rams that generate track tensioning force. The track tensioning system sets and maintains track tension within functional and durability limits. The track tensioning system results in a constant tensioner ram length while operating dynamic track tension force is between 15% and 60% of a maximum track tension limit. When the track tension drops below 15% of the maximum tension, a travel accumulator extends the track tensioning ram and by doing so maintains tension to a minimum of 7% of the maximum track tension limit. When the track tension exceeds 60% of the maximum track tension limit, the tensioning ram is allowed to compress by an overload pressure accumulator to a maximum of 80% belt tension.

The manual pump may include a handle that is secured in the area with components of the track tensioning system. When initially pressurizing the system, the operator can open one or both shut off valves and then actuate the pump via the handle. The right and left system pressure is monitored by the pressure sensors. When the specified system hydraulic pressure is achieved, both shut off valves are closed. If a track or system failure occurs in the field an opposite track will still maintain pressure due to the track tensioning system. If a track failure occurs, the system pressure for that track or belt can be released by opening the shut off valve allowing the pressurized oil to be returned to the reservoir. The track or belt can then be replaced and the system repressurized.

Incorporating the dual accumulators on each track results in a two-stage spring force curve. At ride height, the overload accumulator maintains the set hydraulic pressure during cylinder jounce force inputs between 15% to 60% of threshold. Beyond the 60% threshold, to the 80% maximum, when the cylinder compresses, the accumulator travels and relaxes the tensioner to within acceptable transient levels. During cylinder rebound force inputs, the travel accumulator engages, and maintains positive belt tension through the system feedback. This two-stage system provides a variable on demand track tension in a simplified form for a tracked vehicle.

The track tensioning system also provides a simple and quick independent manual right and left tensioner adjustment for compensation of vehicle cargo loading under use in the field. The track tensioning system also allows pressure equalization between right and left track tensioner systems. The track tensioning system facilitates the ease of replacing a failed track in the field by allowing release of tensioner pressure manually from the affected side only.

The track tensioning system is completely independent of the power unit in the vehicle and does not require the vehicle to be operational when setting or adjusting track tension. The incorporation of the two stage accumulators provides a transparent variable jounce and rebound spring curve that provides the force required to maintain track belt tension.

### Tracked Vehicle

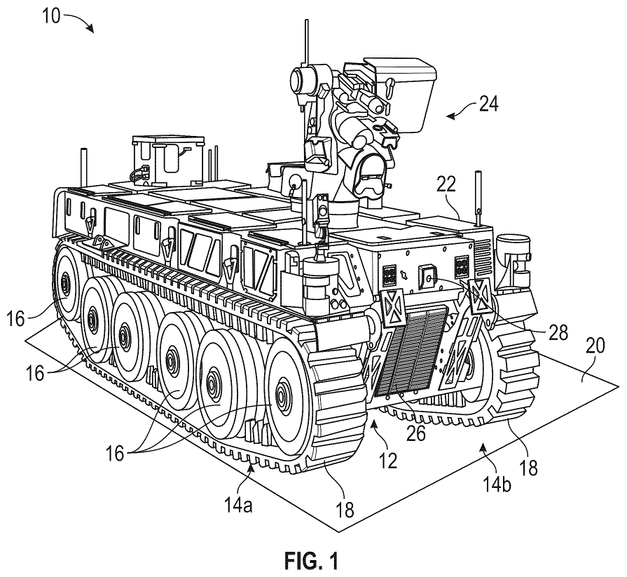

Referring to FIG. 1, a vehicle 10 (e.g., a robotic vehicle, a combat vehicle, an autonomous vehicle, a semi-autonomous vehicle, a remotely controlled combat or fighting vehicle, etc.) includes a body 22 that is coupled with and positioned on a chassis 12 (e.g., a frame). The vehicle 10 may be a tracked vehicle including a first track assembly 14a and a second track assembly 14b positioned on opposite lateral sides of the body 22. The track assemblies 14 are configured to be driven (e.g., by a drive drum) to drive transportation of the vehicle 10 along a ground surface 20. In some embodiments, the track assemblies 14 include multiple followers that are rotatably coupled with the body 22 or the chassis and are driven to rotate by movement of tracks 18. The track assemblies 14 each include multiple rotatable elements 16 (e.g., drums, wheels, gears, sprockets, cylindrical members, etc.) that may include one or more driven rotatable elements and one or more follower rotatable elements. The track assemblies 14 also each include tracks 18 that have the form of an elongated and closed loop member (e.g., a tread, a rubber track, a belt, a resilient material formed in a loop, etc.). The driven rotatable elements may engage an inner surface of the tracks 18 in order to drive rotation or movement of the tracks 18 to transport the vehicle 10.

The vehicle 10 may be a fighting vehicle, a manned vehicle, a military vehicle, an electric military vehicle, an unmanned vehicle, a robotic combat vehicle, etc. The vehicle 10 can include weaponry 24 positioned around the body 22, various telematics or wireless control units, a control system, etc., such that the vehicle 10 can be transported by a remote operator. The vehicle 10 may include one or more sensors 28 (e.g., infrared sensors, cameras, imaging devices, forward looking infrared, lidar sensors, radar sensors, microphones, threat detection systems, etc.) positioned about the body 22. The body 22 may be armored in order to reduce a likelihood of puncture by hostile rounds or weaponry.

The body 22 may also include a grille 26 that includes multiple structural members and openings. The grille 26 may be positioned at a longitudinal end (e.g., a front or forwards facing longitudinal end) of the body 22 and may allow air to transfer into the body 22 to cool components of the vehicle 10.

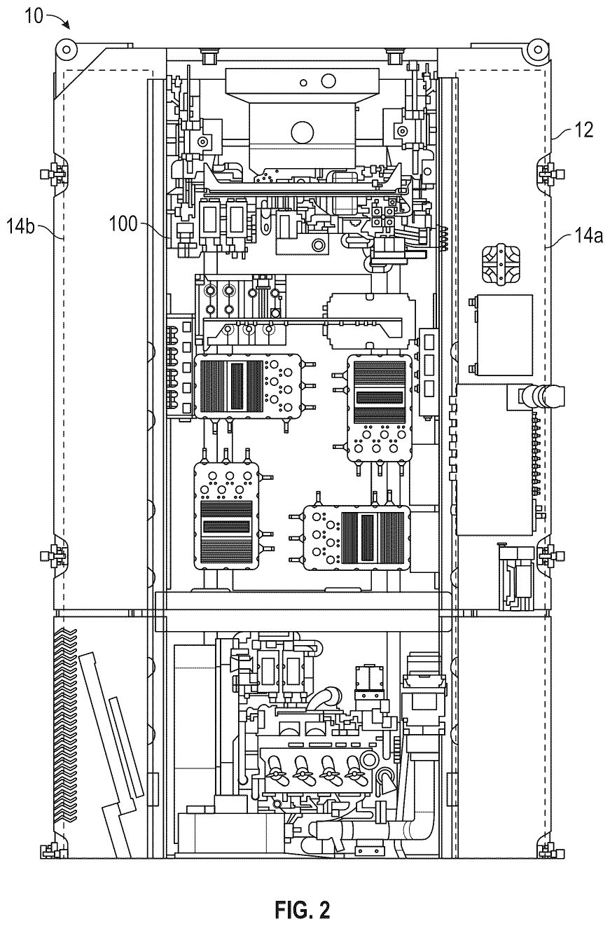

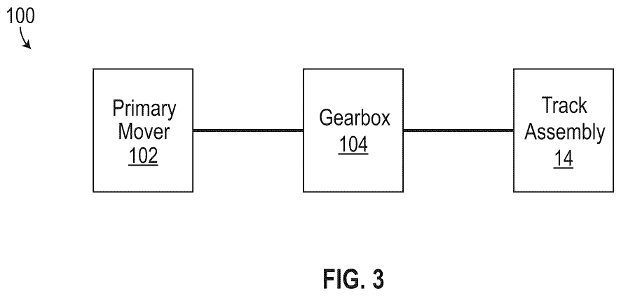

Referring to FIGS. 2 and 3, the vehicle 10 includes a driveline 100 (e.g., a drive system) that is configured to drive one or more rollers, drums, etc., of the track assemblies 14 to thereby drive the tracks 18 and transport the vehicle 10. The vehicle 10 may include a separate driveline 100 for each of the track assembly 14a and the track assembly 14b and may operate the drivelines 100 at different speeds in order to perform steering or turning for the vehicle 10. The driveline 100 may be an electric drive system such that the vehicle 10 uses on-board electrical energy (e.g., batteries, capacitors, cells, energy store systems, etc.) to transport.

As shown in FIG. 3, the driveline 100 may include a primary mover 102 (e.g., an engine, an electric motor, etc.), a gearbox 104, and the track assemblies 14. The driveline 100 may include multiple primary movers 102 and gearboxes 104 in order to independently drive the track assembly 14a and the track assembly 14b at different rates or in different directions to perform turns or steering operations. The gearbox 104 is configured to receive output torque from the primary mover 102 and transfer torque to the driven rotatable elements of the track assemblies 14 to drive the tracks 18 for both transportation and steering of the vehicle 10.

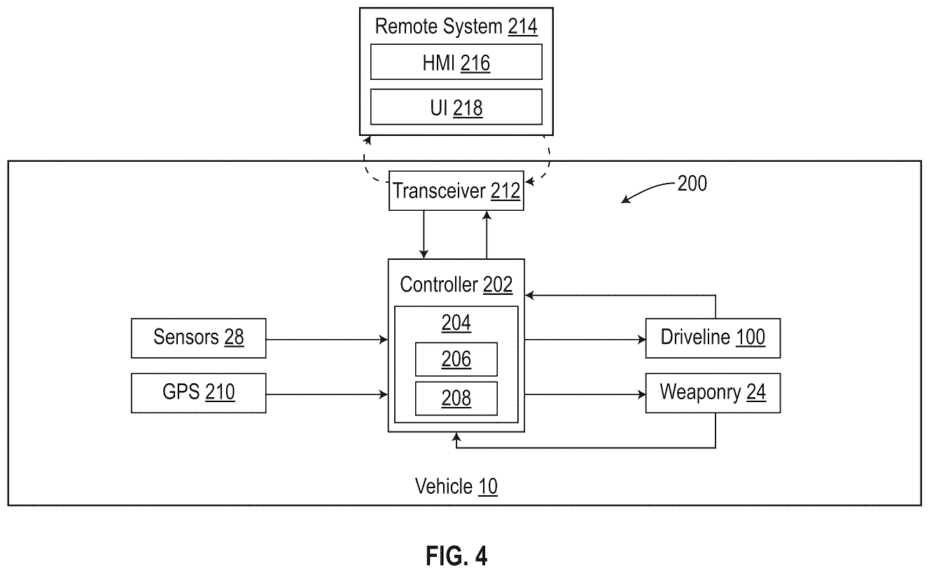

Referring to FIG. 4, the vehicle 10 may include or be a component of a control system 200. The control system 200 includes a controller 202, the sensors 28, a Global Positioning System (“GPS”), the driveline(s) 100, the weaponry 24, a transceiver 212, and a remote system 214. The controller 202 is configured to receive sensor data from the sensors 28 and a GPS location from the GPS 210. The controller 202 may use the sensor data to autonomously control operation of the driveline 100 and the weaponry 24. The controller 202 may also receive feedback from the driveline(s) 100 and the weaponry 24. The controller 202 may communicate with the remote system 214 via the transceiver 212, providing the sensor data, the GPS location, the feedback from the driveline 100, and the feedback from the weaponry 24. The remote system 214 includes a Human Machine Interface (“HMI”) 216 and a user interface (“UI”) 218. The HMI 216 may provide various buttons, input devices, steering wheels, selectors, switches, etc., to obtain an input or requested command for the vehicle 10 from an operator. In some embodiments, the command is a direct command to operate the driveline 100 or the weaponry 24 such that the vehicle 10 is remotely controlled. In some embodiments, the command is a high level command to the vehicle 10 to implement one or more actions such that the vehicle 10 is semi-autonomously controlled.

The controller 202 may also provide any of the sensor data obtained from the sensors 28 (e.g., image data, IR data, FLIR data, threat detection data, radar data, communications, etc.) to the remote system 214 via the transceiver 212. The UI 218 of the remote system 214 may display any of the sensor data, GPS location, or feedback provided to the remote system 214 by the controller 202. In some embodiments, the transceiver 212 of the vehicle 10 is configured to communicate with transceivers 212 of nearby vehicles 10 to form a mesh network. The controller 202 may receive commands from the remote system 214 and operate the driveline 100 and the weaponry 24 to implement the commands.

The controller 202 includes processing circuitry 204 including a processor 206 and memory 208. Processing circuitry 204 can be communicably connected with a communications interface of controller 202 such that processing circuitry 204 and the various components thereof can send and receive data via the communications interface. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to some embodiments, memory 208 is communicably connected to processor 206 via processing circuitry 204 and includes computer code for executing (e.g., by at least one of processing circuitry 204 or processor 206) one or more processes described herein.

The remote system 214 may be structurally similar to the controller 202 and can include processing circuitry, processors, memory, etc. The remote system 214 may be physically remote from the vehicle 10. The remote system 214 may represent a single processing unit or may include multiple processing units or servers that implement any of the processes or techniques described herein in a distributed manner.

### Track Tensioning System

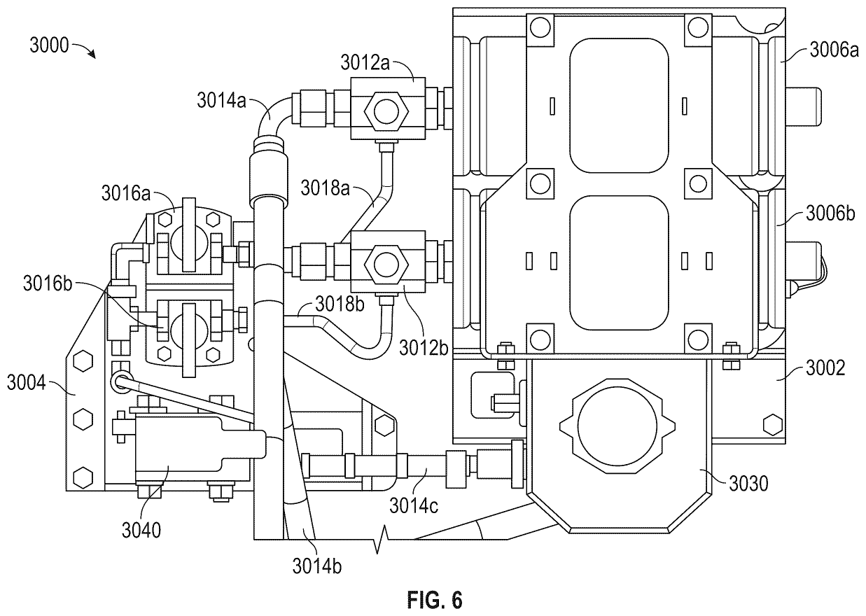

Referring to FIGS. 2, 5-6, and 11, the vehicle 10 includes a track tensioning system 3000 that is configured to control a tension of the tracks 18 during operation of the vehicle 10. The track tensioning system 3000 may include a first frame 3002 (e.g., a structure, a body, etc.) to which a tank 3030 and accumulators 3006 are coupled. The track tensioning system 3000 can also include a manual pump 3040 that is configured to adjust pressurization for the track assembly 14a or the track assembly 14b. The track tensioning system 3000 may include independent shut off valves 3016, and pressure sensors 3012. The track tensioning system 300 can be provided on any tracked vehicle such as work equipment, a skid steer, a tractor, etc.

A first accumulator 3006a of the track tensioning system 3000 is fluidly coupled with a first cylinder 3020a that is configured to adjust or control tensioning of the track 18 of the track assembly 14a via a hydraulic line 3014a (e.g., a hose, a pipe, a conduit, a tubular member, etc.). A second accumulator 3006b of the track tensioning system 3000 is similarly fluidly coupled with second cylinder 3020b that is configured to adjust or control tensioning of the track 18 of the track assembly 14b via a hydraulic line 3014b (e.g., a hose, a pipe, a conduit, a tubular member, etc.). The hydraulic line 3014a is fluidly coupled with a first chamber 3022a of the first cylinder 3020a. The hydraulic line 3014b is similarly fluidly coupled with a first chamber 3022b of the second cylinder 3020b. A first valve 3016a is positioned along the first hydraulic line 3014a, and a second valve 3016b is positioned along the hydraulic line 3014b. The first valve 3016a and the second valve 3016b may be manually operable between an open position or a closed position in order to allow the manual pump 3040 to provide hydraulic fluid into at least one of the lines 3014a or 3014b or to limit the manual pump 3040 from providing hydraulic fluid into at least one of the lines 3014a or 3014b. For example, the valve 3016a and the valve 3016b may allow or limit the exchange of hydraulic fluid between the chambers 3022 of the cylinders 3020 and the tank 3030 via manual pump 3040. In some embodiments, when the valve 3016a and the valve 3016b are transitioned into a closed or shut position, the tank 3030 is isolated from the cylinders 3020. Similarly, when the valve 3016a or the valve 3016b are transitioned into an open position, the manual pump 3040 may be configured to pump additional hydraulic fluid from the tank 3030 through a hydraulic line 3014c to the cylinder 3020a or the cylinder 3020b. In this way, at least one of the valve 3016a or the valve 3016b may be transitioned into the opened position, the manual pump 3040 operated to pressurize the hydraulic line 3014a and the cylinder 3020a or the hydraulic line 3014b and the cylinder 3020b, and then the valve 3016a and the valve 3016b transitioned into the closed or shut position to isolate the cylinders 3020 from the tank 3030 and the manual pump 3040. The pump 3040, the valve 3016a, and the valve 3016b can be coupled (e.g., mounted) to a frame 3004 (e.g., a second frame) that is coupled to the vehicle 10.

The hydraulic line 3014a can include a first pressure sensor 3012a that is configured to measure a pressure in the hydraulic line 3014a. The hydraulic line 3014b can similarly include a second pressure sensor 3012b that is configured to measure a pressure in the hydraulic line 3014b. When initially filling or adjusting pressurization in the hydraulic line 3014a or the hydraulic line 3014b, the pressure sensor 3012a and the pressure sensor 3012b are configured to measure pressurization in the hydraulic lines 3014 which may be provided to an operator or system that is controlling pressurization of the hydraulic lines 3014. The system may use feedback from the pressure sensors 3012 to achieve target or desired pressurization in the hydraulic lines 3014. The first valve 3016a and the second valve 3016b can be fluidly coupled with the first pressure sensor 3012a and the second pressure sensor 312b via hydraulic lines 3018a and 3018b respectively.

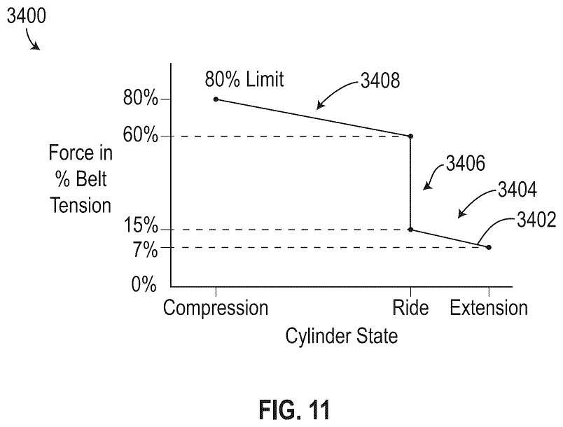

The accumulators 3006 may each include a first accumulator chamber 3008a and a second accumulator chamber 3010a. For example, as shown in FIG. 11, the accumulator 3006a includes both the first accumulator chamber 3008a and the second accumulator chamber 3010a, and the accumulator 3006b includes both the first accumulator chamber 3008b and the second accumulator chamber 3010b. The first accumulator chambers 3008 may be pressurized to a first pressure, P₁, while the second accumulator chambers 3010 are pressurized to a second pressure, P₂. The second pressure P₂ may be greater than the first pressure P₁. In this way, the accumulators 3006 can be dual accumulators. The first chambers 3008 and the second chambers 3010 may be pressurized using a gas. The gas may be pressurized and act upon a first side of a bladder, a piston, or any other movable member. Hydraulic fluid from corresponding of the piston 3020a or the piston 3020b may be received within a chamber on an opposite side of the first chambers 3008 and second chambers 3010 and exert force or pressurization on a second side of the bladder, piston, or other movable members of the accumulators 3006.

Referring particularly to FIG. 11, each of the cylinders 3020 can include the corresponding chamber 3022 and rods 3026. For example, the cylinder 3020a may include the chamber 3022a, a piston 3024a, and a rod 3026a coupled with the piston 3024a. The piston 3024a and the rod 3026a can be movable responsive to inflow or outflow of hydraulic fluid of the chamber 3022a. The rod 3026a may engage a corresponding portion of the track assembly 14a (e.g., a tensioning follower of the rotatable elements 16, the track 18, etc.) such that extension of the rod 3026a (e.g., translation out of the cylinder 3020a, thereby increasing the volume of the chamber 3022a and drawing hydraulic fluid) results in increased tensioning of the track 18 and retraction or compression of the rod 3026a (e.g., translation into the cylinder, thereby decreasing the volume of the chamber 3022a and expelling hydraulic fluid) results in decreased tensioning of the track 18. The cylinder 3020b may similarly be configured and includes a piston 3024b, a rod 3020b, etc., and is configured to act upon a similar member of the track assembly 14b.

When the rods 3026 retract (e.g., compress) into the cylinders 3020 (e.g., due to bumps on the ground surface 20 during transportation of the vehicle 10), the chambers 3022 decrease in volume, and the pistons 3024 push hydraulic fluid into the hydraulic lines 3014. The hydraulic fluid may be forced into the chambers of the accumulators 3006 that oppose the pressurization of the gases at pressures P₁ and P₂. The pressurization of the chambers 3008 and 3010 can be configured in order to maintain, during normal driving operations, the track assemblies 14 at a constant tension.

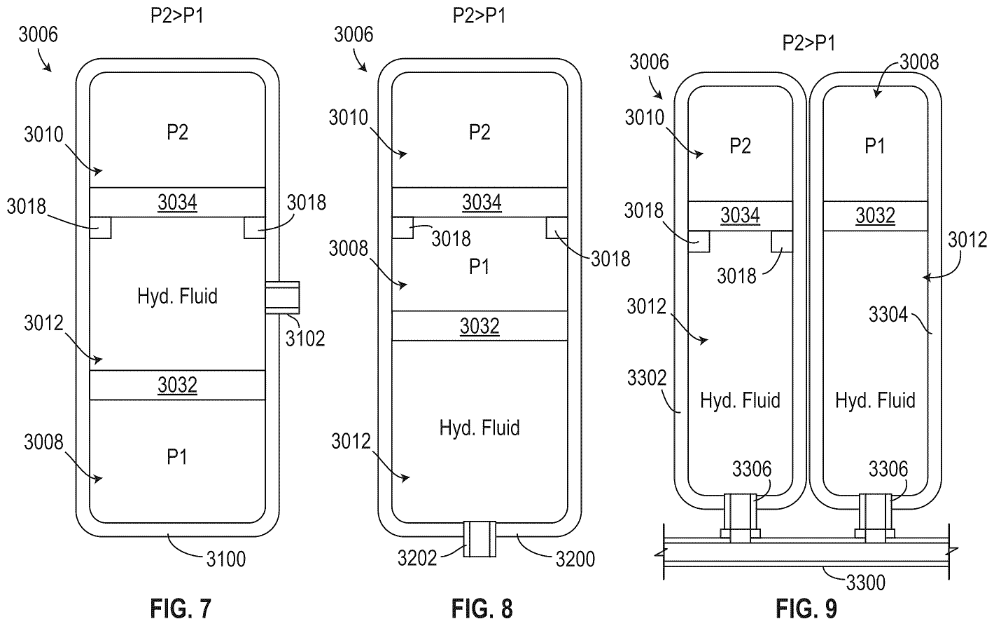

Referring to FIGS. 7-9, the accumulators 3006 may be configured in a variety of ways to provide dual-pressurization. It should be understood that while the description of FIGS. 7-9 as described herein is with reference to a single accumulator 3006, the description of the accumulators 3006 as described herein may apply to both the accumulator 3006a and the accumulator 3006b.

As shown in FIG. 9, the first chamber 3008 is defined by a container 3304 (e.g., a body, a sidewall, a canister, a piston body, etc.) that is separate from a container 3302 (e.g., a body, a sidewall, a canister, a piston body, etc.) that defines the second chamber 3010. The container 3302 may also define a hydraulic chamber 3012 that is fluidly coupled with a hydraulic line 3300 (e.g., hydraulic line 3014a or hydraulic line 3014b) through a coupler 3306 (e.g., a neck, a passageway, etc.). Similarly, the container 3304 may also define a hydraulic chamber 3012 that is fluidly coupled with the hydraulic line 3300. The container 3304 that defines the chamber 3008 (e.g., including gas pressurized to P₁) can include a piston 3032. The piston 3032 may define a separation or barrier between the hydraulic chamber 3012 and the chamber 3008. The gas in the chamber 3008 that is pressurized to pressure P₁ exerts a force on a first side of the piston 3032 while the hydraulic fluid in the hydraulic chamber 3012 exerts a force on a second side of the piston 3032. The piston 3032 may be translatable along a length of the container 3304 thereby resulting in varying compression and force application of the gas in the chamber 3008. The piston 3032 may sealably couple with inner walls of the container 3304 such that exchange of hydraulic fluid and gas between the chamber 3008 and the hydraulic chamber 3012 is limited. The container 3302 similarly includes a piston 3034 that defines the boundary or barrier between the gas in the chamber 3010 at pressure P₂ and the hydraulic chamber 3012. The gas in the chamber 3010 may exert a force on a first side of the piston 3034 while the hydraulic fluid exerts a force on a second side of the piston 3034. The container 3302 may also include stops 3018 (e.g., a shoulder, a limiter, etc.) that limits translation of the piston 3034 beyond a certain point. In this way, since the container 3302 and the container 3304 are both fluidly coupled with the same hydraulic line 3300, via couplers 3306, the piston 3034 does not translate until the piston 3032 has been bottomed out (e.g., translated to maximum) by the hydraulic fluid that returns along the hydraulic line 3300 into the hydraulic chamber 3012.

Referring particularly to FIG. 8, the chamber 3010 and the chamber 3018 may be disposed in a common container 3200 (e.g., a housing, a capsule, a pressure vessel, an accumulator housing, etc.). The chamber 3010 and the chamber 3018 may be serially arranged with the piston 3032 being adjacent the hydraulic fluid in the hydraulic chamber 3012. A neck 3202 may fluidly couple the hydraulic chamber 3012 with one of the hydraulic lines 3014. In this way, when hydraulic fluid is driven into the hydraulic chamber 3012 by the corresponding cylinder 3020, the piston 3032 may first begin to translate in a direction of force exerted by the hydraulic fluid as the hydraulic fluid enters the hydraulic chamber 3012. The gas in the chamber 3008 may, similarly to the implementation shown in FIG. 9, provide reactive damping force to the piston 3032 in order to thereby maintain constant tension in the track assembly 14. If the pressure exerted by the hydraulic fluid on the piston 3032 exceeds a capacity of the gas in the chamber 3008, the piston 3034 may begin moving and thereby the gas in the chamber 3010 is activated to provide reactive pressure to the second piston 3034 and the first piston 3032. The piston 3034 may be limited from translating in a direction towards the hydraulic fluid in the hydraulic chamber 3012 by the stops 3018, but allowed to translate away from the hydraulic fluid in the hydraulic chamber 3012 when pressure exerted by the hydraulic fluid is sufficiently high.

Referring to FIG. 7, the chamber 3008 and the chamber 3010 may both be defined within and disposed at opposite ends of a common container 3100. The common container 3100 may be similar to the container 3200 but with a different arrangement of the chamber 3008 and the chamber 3010, as shown. The container 3100 may similarly include a coupler 3102 (e.g., a neck, an opening, an outlet, an ingress or egress point, a connector, etc.) similar to the neck 3202 (e.g., a coupler) to fluidly couple the hydraulic chamber 3012 with the hydraulic line 3014a or the hydraulic line 3014b. The hydraulic chamber 3012 may be disposed between the chamber 3008 and the chamber 3010. Similar to the embodiments described above with reference to FIGS. 8 and 9, the container 3100 includes the piston 3032 and the piston 3034. The embodiment of the accumulator 3006 as shown in FIG. 7 may function similarly to the embodiment of the accumulator shown in FIG. 8, but with the chamber 3008 and the chamber 3010 disposed on opposite ends of the hydraulic chamber 3012 instead of serially arranged above the hydraulic chamber 3012.

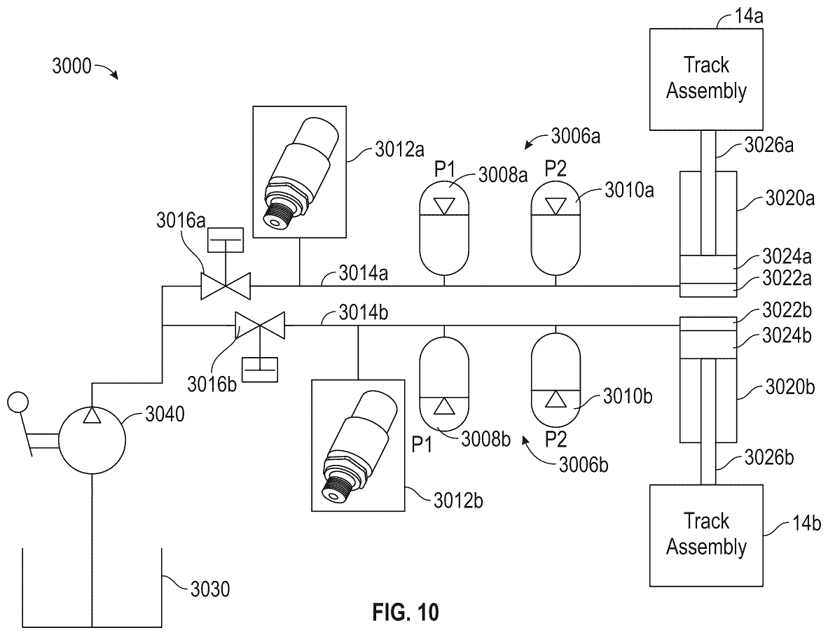

Referring to FIG. 10, the track tensioning system 3000 may set and maintain tension in the tracks 18 of each of the track assembly 14a and the track assembly 14b. The pressurization due to the gas in the chambers 3008a and 3010a may result in the length of the rods 3026 being held at a constant position (e.g., constant tensioner ram length) while vehicle operations resulting in dynamic track tension force between substantially 15% and 60% of a maximum track tension limit. While the vehicle 10 is at a ride height, the pressurization of the accumulators 3006 (e.g., the pressurization P₂ in the chambers 3010) may result in maintaining the rods 3026 (e.g., tensioning rods, ram rods, etc.) at a constant or substantially unchanging position as the tracks 18 experience tensioning forces that range from substantially 15% to 60% of the maximum track tension limit. During cylinder rebound force inputs, when the tension of one or more of the tracks 18 decrease below 15% of the maximum track tension limit, the first accumulator chamber 3008a corresponding to the tracks 18 that experience tensioning below 15% of the maximum track tension limit may activate, thereby driving extension of the corresponding rods 3026 in order to exert a force on the tracks 18 that maintains at least a tension of 7% of the maximum track tensioning limit. Accordingly, even when the track tension significantly decreases (e.g., due to rebounds), a positive track tension of at least 7% of the maximum track tension limit is maintained due to the pressurization of the gases in the first accumulator chambers 3008a.

During scenarios in which the track tensioning exceeds 60% of the maximum track tension limit (e.g., due to jounces, bumps, etc.), the cylinders 3020 may compress (e.g., the rods 3026 are driven into the cylinders 3020). Compression of the cylinders 3020 may result in activation of the corresponding second accumulator chambers 3010 which allow the rods 3026 to compress without allowing the tension in the tracks 18 to exceed 80% of the maximum track tension limit. Over time, as the tracks 18 wear out and increase in overall length, the tension in the tracks 18 may decrease, requiring re-pumping of hydraulic fluid by use of the manual pump 3040 into the hydraulic lines 3014.

Referring to FIG. 11, a graph 3400 illustrates belt tension (e.g., belt tension in terms of a percent of maximum allowable belt tension) with respect to cylinder state (e.g., the cylinder 3020a or the cylinder 3020b). It should be understood that while the description of FIG. 11 herein is with reference to a single hydraulic path of the belt tensioning system 3000, both of the hydraulic circuits of FIG. 10 may operate similarly and independently (e.g., the first hydraulic path being the cylinder 3020a, the hydraulic line 3014a, and the first accumulator 3006a that serves the track assembly 14a, and the second hydraulic path being the cylinder 3020b, the hydraulic line 3014b, and the second accumulator 3006b).

The graph 3400 includes a series 3402 that includes a cylinder extension region 3404, a cylinder compression region 3408, and a ride region 3406 at which the cylinder 3020 is at a constant position. The cylinder 3020 may be maintained at a constant position due to the corresponding accumulator 3006 during ride height events where the track tension dynamically varies from a first value (e.g., 15% of the maximum track tension limit) and a second value (e.g., 60% of the maximum track tension limit). If the track tension drops below the first value (e.g., below 15% of the maximum track tension limit) due to cylinder rebound events or events where the ride height changes (e.g., increases), the cylinder 3020 may cross into the cylinder extension region 3404 and begin to extend. The first accumulator chamber 3008 (e.g., a travel extension accumulator) may drive the rod 3026 of the cylinder 3020 in order to maintain at least a minimum desirable track tensioning value (e.g., 7% of the maximum track tension limit). If the track tension exceeds the second value (e.g., exceeds 60% of the maximum track tension limit), the cylinder 3020 may be allowed to compress (e.g., the rod 3026 may translate into the cylinder 3020) and the second accumulator chamber 3010 (e.g., an overload accumulator) may activate and limit the track tension from exceeding a maximum desirable track tensioning value (e.g., 80% of the maximum track tension limit). The second accumulator chamber 3010 may limit the track tension from exceeding the maximum desirable track tensioning value by compressing and providing a reactive force or pressure (e.g., P₂).

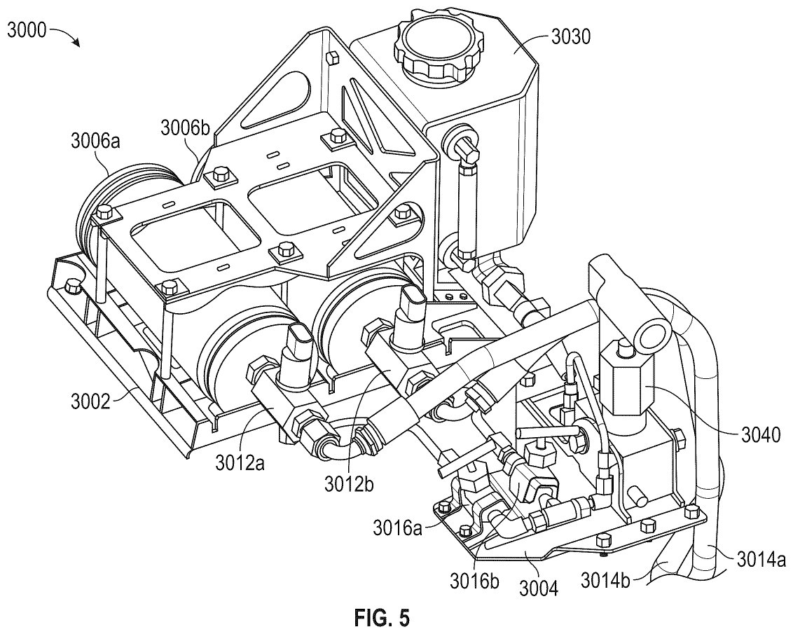

Referring generally to FIGS. 5-11, the track tensioning system 3000 advantageously does not require pumps or motors to maintain desired tensioning in the tracks 18 of the track assemblies 14a (e.g., belt assemblies). Further, the track tensioning system 3000 enables independent track tension control of each of the track assemblies 14. If a track or system failure occurs in the field to one of the track assemblies 14, the other of the track assemblies 14 is still maintained at desired or allowed track tension. Further, if a track failure occurs in the field, the pressurization of the corresponding hydraulic line 3014 can be released by opening the associated valve 3016 to relieve pressure and allow the hydraulic fluid to transfer back into the tank 3030. The track assembly 14 that experiences the track failure may, after being depressurized by opening the associated valve 3016, be replaced and the hydraulic line 3014 for that track assembly 14 may be repressurized (e.g., by opening the associated valve 3016 and operating the manual pump 3040).

Incorporating the dual accumulators 3006 on each track assembly 14 results in the two-stage spring force curve shown in FIG. 11. At ride height of the vehicle 10, the overload accumulator (e.g., accumulator chamber 3010) maintains the set hydraulic pressure during cylinder jounce force inputs between 15% to 60% of threshold (e.g., track tensioning limit). Beyond the 60% threshold, to the 80% maximum, when the cylinder compresses, the accumulator chamber 3010 (e.g., the overload accumulator) travels and relaxes the tensioner (e.g., the cylinder 3020) to within acceptable transient levels. During cylinder rebound force inputs, the travel accumulator (e.g., the accumulator chamber 3008) engages, and maintains positive belt tension through the system feedback. The two-stage belt tensioning system 3000 provides a variable on demand track tension in a simplified form for a tracked vehicle. Further, the belt tensioning system 3000 is completely independent of power units (e.g., the driveline 100) for transporting the vehicle 10 and does not require the vehicle 10 to be operational when setting or adjusting track tension. The use of the accumulators 3006 having differently pressurized and separate accumulator chambers provides a transparent variable jounce and rebound spring curvature that provides sufficient force to maintain desired track or belt tension.

The track tensioning system 3000 also provides a simple and quick independent manual right and left tensioner adjustment for compensation of cargo loading of the vehicle 10 under use in the field (e.g., by selectively using the valves 3016 and the manual pump 3040 to provide additional hydraulic fluid). The track tensioning system 3000 also provides a simple means of pressure equalization between right and left hydraulic lines 3014 (e.g., track tensioner branches). The track tensioning system 3000 also facilitates ease of replacing a failed track 14 in the field by allowing an operator to release tensioner pressure manually from the affected side only (e.g., by opening the valves 3016).

The track tensioning system 3000 can provide constant tension to a vehicle track system (e.g., track assemblies 14) over various terrain. The track tensioning system 3000 also advantageously includes a manual override pump 3040 and tank 3030 (e.g., a reservoir). The integral manual pump and reservoir provide the ability to set the system pressure or evacuate pressure independently from side to side to assist in field track removal and installation service. The track tensioning system 3000 also provides the ability quickly equalize and set right and left track tensioner pressure in the field with the addition of various cargo loads.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle 10 as shown in the various exemplary embodiments is illustrative only. Additionally, any element disclosed in one embodiment may be incorporated or utilized with any other embodiment disclosed herein.

1. A military vehicle comprising:
a pair of track assemblies, each track assembly comprising a belt and a plurality of rollers positioned within the belt, the pair of track assemblies configured to be driven to transport the military vehicle; and
a track tensioning system comprising:
a pair of dual accumulators, the pair of dual accumulators configured to adjust a tension of the belt of a corresponding track assembly, wherein each of the pair of dual accumulators include a first accumulator chamber at a first pressure, and a second accumulator chamber at a second pressure, the second pressure being greater than the first pressure, wherein the first accumulator chamber and the second accumulator chamber are partially defined by a common housing of the pair of dual accumulators;
wherein the track tensioning system is configured to provide two-stage control of the tension of the belt.

2-3. (canceled)

4. The military vehicle of claim 1, wherein the first accumulator chamber and the second accumulator chamber are partially defined by separate housings.

5. The military vehicle of claim 1, wherein a chamber opposite each of the first accumulator chamber and the second accumulator chamber is fluidly coupled with a compression chamber of a corresponding cylinder, the corresponding cylinder comprising a rod configured to extend and retract to engage the belt and adjust the tension of the belt.

6. The military vehicle of claim 1, wherein the pair of dual accumulators are configured to maintain a constant position of a rod of a corresponding cylinder when the military vehicle is at ride height across an allowed range of values of the tension of the belt.

7. The military vehicle of claim 6, wherein the allowed range of values of the tension of the belt comprise a range spanning 15% of a maximum belt tension limit and 60% of the maximum belt tension limit.

8. The military vehicle of claim 1, wherein, in response to an event in which the tension of the belt decreases below a lower limit of the allowed range of values, the first accumulator chamber is configured to drive a rod of a corresponding cylinder to extend to maintain at least a minimum allowable tension in the belt.

9. The military vehicle of claim 8, wherein the minimum allowable tension in the belt is 7% of a maximum belt tension limit.

10. The military vehicle of claim 1, wherein, in response to an event in which the tension of the belt increases above an upper limit of the allowed range of values, the second accumulator chamber is configured to allow compression of a rod of a corresponding cylinder without allowing the tension in the belt to exceed a maximum allowable tension.

11. The military vehicle of claim 10, wherein the maximum allowable tension is 80% of a maximum belt tension limit.

12. The military vehicle of claim 1, wherein the track tensioning system further comprises:
a reservoir configured to provide hydraulic fluid;
a manual pump fluidly coupled with the reservoir;
a pair of hydraulic lines each fluidly coupled with the manual pump, a corresponding cylinder configured to adjust the tension in the belt, and a corresponding one of the pair of dual accumulators;
a pair of shut off valves, each shut off valve positioned along one of the pair of hydraulic lines; and
a pair of pressure sensors, each pressure sensor position along one of the pair of hydraulic lines.

13. The military vehicle of claim 12, wherein the manual pump is operably configured to drive hydraulic fluid from the reservoir into at least one of the pair of hydraulic lines based on which of the pair of shut off valves are in an open position.

14. A track tensioning system, comprising:
a pair of dual accumulators, the pair dual accumulators configured to adjust a tension of a belt of a corresponding track assembly, wherein the pair of dual accumulators include a first accumulator chamber at a first pressure, and a second accumulator chamber at a second pressure, the second pressure being greater than the first pressure, wherein the first accumulator chamber and the second accumulator chamber are partially defined by a common housing of the pair of dual accumulators;
wherein the track tensioning system is configured to provide two-stage control of the tension of the belt.

15-16. (canceled)

17. The track tensioning system of claim 14, wherein the first accumulator chamber and the second accumulator chamber are partially defined by separate housings.

18. The track tensioning system of claim 14, wherein a chamber opposite each of the first accumulator chamber and the second accumulator chamber is fluidly coupled with a compression chamber of a corresponding cylinder, the corresponding cylinder comprising a rod configured to extend and retract to engage the belt and adjust the tension of the belt.

19. The track tensioning system of claim 14, wherein the allowed range of values of the tension of the belt comprise a range spanning 15% of a maximum belt tension limit and 60% of the maximum belt tension limit.

20. (canceled)
